(19) United States
(12) Patent Application Publication
(10) Pub. No.: US 2009/0278532 A1
(43) Pub. Date: Nov. 12, 2009

(54) Angular position sensing device

(76) Inventor: Warren Gordon Pettigrew, Christchurch (NZ)

Correspondence Address: KENYON & KENYON LLP, 1500 K STREET N.W., SUITE 700, WASHINGTON, DC, 20005, US

(21) Appl. No.: 11/991,257

(22) PCT Filed: Aug. 31, 2006
(86) PCT No.: PCT/NZ2006/000223

§ 371 Date: May 16, 2008

(30) Foreign Application Priority Data
Sep. 2, 2005 (NZ) 542172

(51) Int. Cl. G01B 7/30

(52) U.S. Cl. 324/207.21; 324/207.25

(57) ABSTRACT

An angular position sensing device suitable for use in a mobility vehicle, particularly as a speed control input device. First and second magnetic sensors are rotationally offset with respect to each other within a plane and orientated and connected such that their outputs are complementary and related to magnetic field direction. A magnetic field source is provided rotatable relative to the first and second sensors within the plane such as to vary the direction of a magnetic field applied to the first and second sensors. A sensing circuit monitors the outputs of the sensors and provides an output which may be used as a speed control input for an electric vehicle. The magnetic sensors are preferably giant magneto resistive magnetic sensors having a sine/cosine relationship.

### FIELD OF THE INVENTION

The present invention relates to an angular position sensing device suitable for use in a mobility vehicle, particularly as a speed control input device.

### BACKGROUND

Potentiometers are the most commonly used speed input devices for mobility vehicles. Potentiometers suffer from the risk of open circuiting of the potentiometer wiper or a broken connection, which can lead to a “runaway” situation in a mobility vehicle. Potentiometers are also susceptible to wear resulting in unreliable and unsafe behaviour.

It has been recognised that there is a need for an angular position sensing device for speed control of mobility vehicles having improved reliability and safety.

Electrostatic and optical input devices require rigorous sealing to ensure reliable operation. This adds to the complexity and cost. Optical encoders have sufficient resolution but are expensive.

Hall or magneto resistive magnetic field strength sensors have outputs which vary according to the applied magnetic field strength. These require careful magnetic circuit design, control of magnetic field strength and shielding to external fields. Further, single bridge embodiments do not provide device error detection.

It would be desirable to provide an angular position sensing device for mobility vehicles that provides improved reliability and safety whilst being relatively inexpensive.

### SUMMARY OF THE INVENTION

According to a first aspect of the invention there is provided an angular position sensing device for a mobility vehicle comprising:
a. first and second magnetic sensors rotationally offset with respect to each other within a plane, orientated and connected such that their outputs are complementary and related to magnetic field direction;
b. a magnetic field source rotatable relative to the first and second sensors within the plane such as to vary the direction of a magnetic field applied to the first and second sensors; and
c. a sensing circuit which monitors the outputs of the sensors.

According to a further aspect of the invention there is provided an angular position sensing device for a mobility vehicle comprising:
a. first and second bridges formed of magnetic sensors, wherein each bridge is rotationally offset with respect to the other bridge within a plane such as to produce outputs which have a cosine/sine relationship in relation to the magnetic field angle.
b. a magnetic field source rotatable relative to the first and second bridges within the plane such as to vary the direction of a magnetic field applied to the bridges as the magnetic field source is rotated;
c. a power supply which provides power across the first and second bridges; and
d. a sensing circuit which monitors voltages across the bridges.

### BRIEF DESCRIPTION OF THE DRAWINGS

The invention will now be described by way of example of preferred embodiments with reference to the accompanying drawings in which:

FIG. 1 shows a schematic diagram of an angular position sensing device according to first embodiment;

FIG. 2 shows the mechanical construction of a sensing device of a preferred embodiment;

FIG. 3 shows the relationship of outputs of the angular position sensing device of FIG. 1;

FIG. 4 shows a circuit for conditioning the output from one bridge;

FIG. 5 shows a schematic diagram of an angular position serising device; and

FIG. 6 shows a schematic diagram of a mobility vehicle control system according to one embodiment.

### DETAILED DESCRIPTION

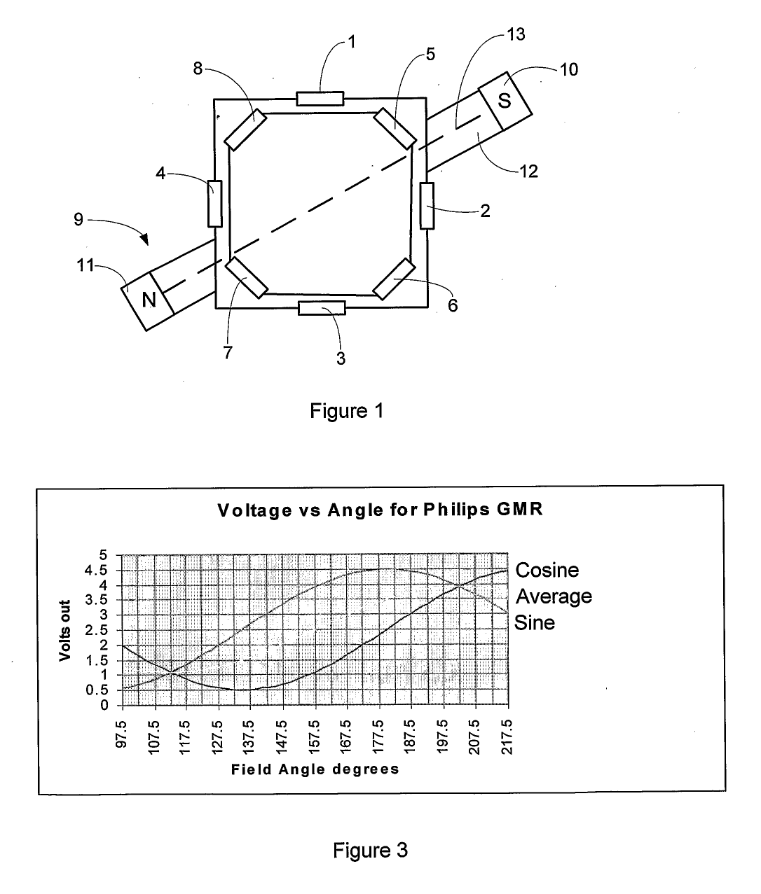

Referring firstly to FIG. 1 a schematic diagram of a preferred arrangement according to a first embodiment is shown. A first bridge consists of magnetic sensor elements 1 to 4 and a second bridge consists of magnetic sensor elements 5 to 8. A magnetic field source 9, in the form of permanent magnets 10 and 11 and steel backing plate 12 is rotatable in the plane of the bridges so that the principal magnetic field direction 13 scans the magnetic sensor elements as it is rotated. Whilst a bridge consisting solely of magnetic sensor elements is preferred it will be appreciated that a bridge having one or more magnetic sensor elements could be used.

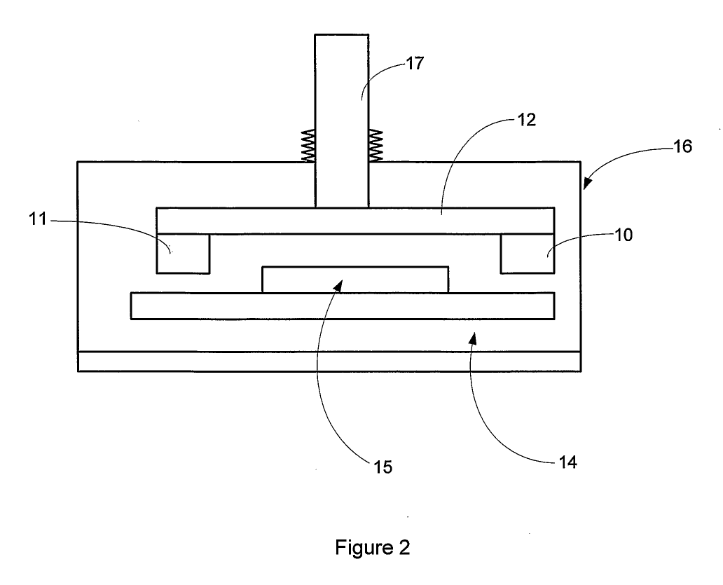

A possible physical construction of an angular position sensing device packaged in potentiometer type housing is shown in FIG. 2. The cross-sectional view shows a circuit board 14 including magnetic bridge sensing device 15 located within housing 16. Magnets 10 and 11 secured to steel backing plate 12 which is rotatable relative to magnetic bridge sensing device 15 by rotation of shaft 17.

The bridges may be provided in a single device such as a Philips KMZ41. As the device is responsive to magnetic field direction, rather than strength, the circuit is relatively immune to external magnetic fields and the magnetic circuit design is greatly simplified. Magnetic sensor elements 1 to 4 are offset with respect to magnetic sensor elements 5 to 8 such that the outputs of the bridges have a sine/cosine relationship, or any other suitable relationship, as shown in FIG. 3. It will be seen that the average value between the sine and cosine curves is relatively linear for magnetic field angles of between 127.5° to 187.5°.

The fact that the outputs of the two bridges have a sine/cosine relationship means that the output values of the two bridges may be compared to check that this relationship is present. If the outputs do not have a sine/cosine relationship, within a predetermined tolerance (for example +/−10%) an error condition can be signalled to a vehicle controller.

The bridge supply and sensing circuit must satisfy thermal stability requirements whilst providing appropriate excitation of the bridges.

At a fixed voltage excitation, the bridge has a typical temperature signal strength coefficient of −0.31%/K.

Over the specified operating temperature range (−25 to +50° C.) this would lead to a variation in sensitivity of: 75×0.31=23.5%.

This is well outside of acceptable limits.

If fixed current excitation is used, the bridge's temperature coefficient of resistance of +0.34%/K produces a counteracting effect by increasing the bridge voltage as temperature increases, resulting in a net temperature coefficient of −0.34−0.31=+0.03%/K

Over the specified operating temperature range this would lead to a variation in sensitivity of −75×0.03=2.25%, which is acceptable for this application.

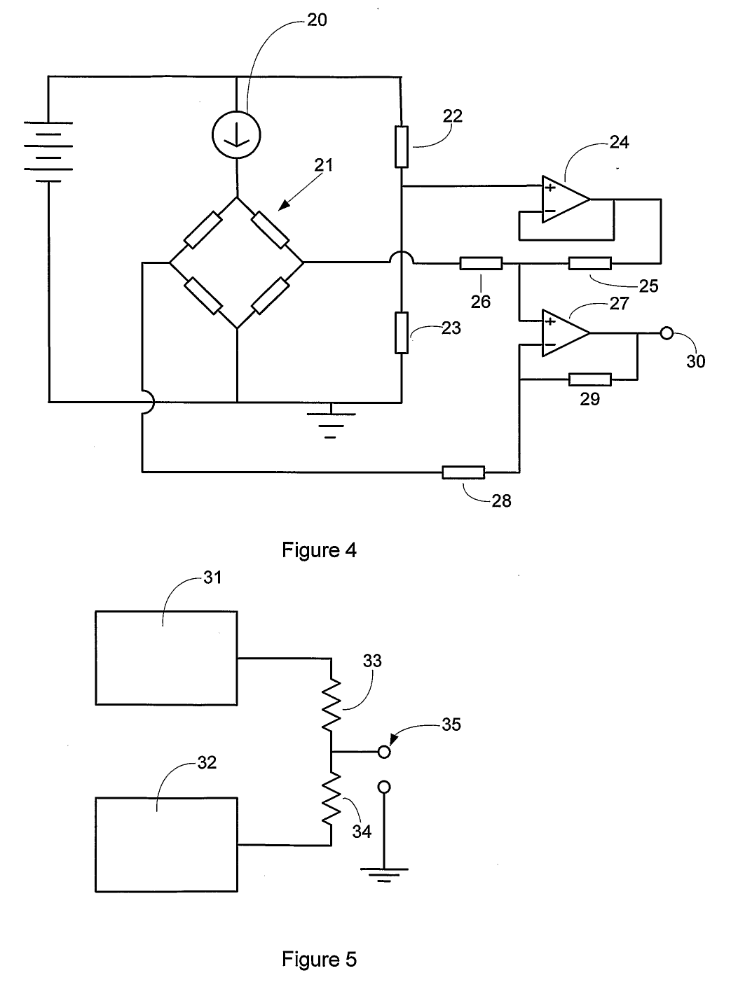

Referring to FIG. 4 a possible sensing circuit for one of the bridges is shown. In the circuit a constant current supply 20 biases sensing bridge 21. Resistors 22 and 23 form a voltage divider which supplies a reference voltage to buffer 24. Resistors 25 and 26 form a voltage divider between the output buffer 24 and one limb of bridge 21. The output of voltage divider 26 and 25 is applied to the non-inverting input of operational amplifier 27. The output of the other limb of bridge 21 is applied to the inverting input of operational amplifier 27 via resistor 28. Resistors 28 and 29 govern the gain of operational amplifier 27. The output of the circuit is thermally compensated as described above.

FIG. 5 shows a circuit in which circuits 31 and 32 are circuits of the form shown in FIG. 4, one producing a sine output and the other a cosine output. The voltage divider formed by resistors 33 and 34 produces an output 35 that is an average of the sine and cosine values. This arrangement may be used were a single analogue input is required as a control input.

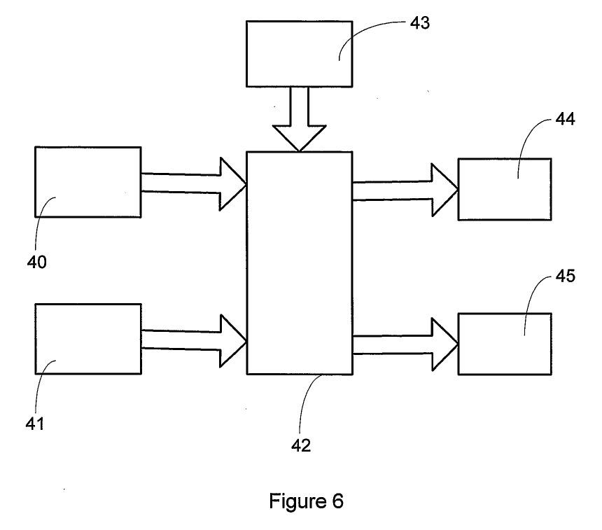

Referring now to FIG. 6 a schematic diagram of a vehicle control system according to one embodiment is shown. Sensing circuits 40 and 41, of the form shown in FIG. 4, supply sine and cosine inputs to microprocessor 42. Microprocessor 42 also receives steering control input from input device 43 where steering is not performed mechanically. Microprocessor 42 provides output controls to wheel drive circuits 44 and 45. In this embodiment the sine and cosine values supplied by circuits 40 and 41 are converted into digital form. Microprocessor 42 controls drive circuits 44 and 45 on the basis of these digital inputs and the inputs from input device 43.

Microprocessor 42 determines whether the inputs from circuits 40 and 41 exhibit a sine/cosine relationship. If the inputs differ from a sine/cosine relationship by a predetermined amount an error processing routine may be initiated. This may lead to drive circuits 44 and 45 being disabled where microprocessor 42 determines that the inputs from circuits 40 and 41 are unreliable. Alternatively, microprocessor 42 may continue to utilise one input from circuit 40 or circuit 41 if it determines that only one circuit is malfunctioning (e.g. no signal from one circuit). This double sensing provides additional safety and mobility vehicle manufacturers can determine the safety levels they wish to implement in software.

The invention thus provides an angular position sensing device for mobility vehicles that is compact, inexpensive and mechanically and electrically compatible with existing potentiometers. It is linear and accurate, has a long usable life and is relatively unaffected by external magnetic fields. It also enables improved safety and failsafe operation to be implemented.

While the present invention has been illustrated by the description of the embodiments thereof, and while the embodiments have been described in detail, it is not the intention of the Applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departure from the spirit or scope of the Applicant's general inventive concept.

1. An angular position sensing device for a mobility vehicle comprising:
a. first and second magnetic sensors rotationally offset with respect to each other within a plane, orientated and connected such that their outputs are complementary and related to magnetic field direction;
b. a magnetic field source rotatable relative to the first and second sensors within the plane such as to vary the direction of a magnetic field applied to the first and second sensors; and
c. a sensing circuit which monitors the outputs of the sensors.

2. An angular position sensing device as claimed in claim 1 wherein each magnetic sensor is a bridge including at least one magnetic sensing element.

3. An angular position sensing device as claimed in claim 2 wherein each bridge is formed of magnetic sensing elements which are rotationally offset with respect to each other within the plane and orientated and connected such that the outputs of the bridges are complementary.

4. An angular position sensing device as claimed in claim 1 wherein the magnetic sensors are giant magneto resistive magnetic sensors.

5. An angular position sensing device as claimed in claim 1 wherein the outputs of the sensors have a predetermined relationship.

6. An angular position sensing device as claimed in claim 1 wherein the sensing circuit detects an error if the outputs of the first and second magnetic sensors vary from the predetermined relationship by a predetermined amount.

7. An angular position sensing device as claimed in claim 5 wherein the predetermined relationship is a sine/cosine relationship.

8. An angular position sensing device as claimed in claim 1 including a power supply which supplies power to the bridges so as to provide thermal stability of the outputs.

9. An angular position sensing device as claimed in claim 8 wherein the power supply supplies a substantially constant current.

10. An angular position sensing device as claimed in claim 1 wherein the magnetic field source is a permanent magnet.

11. An angular position sensing device for a mobility vehicle comprising:
a. first and second bridges formed of magnetic sensors, wherein each bridge is rotationally offset with respect to the other bridge within a plane such as to produce outputs which have a cosine/sine relationship in relation to the magnetic field angle.
b. a magnetic field source rotatable relative to the first and second bridges within the plane such as to vary the direction of a magnetic field applied to the bridges as the magnetic field source is rotated;
c. a power supply which provides power across the first and second bridges; and
d. a sensing circuit which monitors voltages across the bridges.

12. A mobility vehicle including an angular position sensing device as claimed in claim 11.

13. A mobility vehicle as claimed in claim 12 wherein the angular position sensing device supplies speed demand input signals.

14. A mobility vehicle including an angular position sensing device as claimed in claim 1.

15. A mobility vehicle as claimed in claim 14 wherein the angular position sensing device supplies speed demand input signals.
